(19) United States
(12) Patent Application Publication
(10) Pub. No.: US 2024/0420653 A1
(43) Pub. Date: Dec. 19, 2024

(54) BACKLIGHT MODULE AND DRIVING METHOD THEREFOR, AND DISPLAY PANEL AND DISPLAY APPRATUS

(71) Applicants: Hefei BOE Ruisheng Technology Co., Ltd., Hefei (CN); BOE Technology Group Co., Ltd., Beijing (CN)

(72) Inventors: Fei XU, Beijing (CN); Liguang GENG, Beijing (CN); Sijia SUN, Beijing (CN); Xiaopeng LIU, Beijing (CN); Tao MA, Beijing (CN); Xiaoli WANG, Beijing (CN); Chengbing ZHU, Beijing (CN); Haiwei SUN, Beijing (CN)

(73) Assignees: Hefei BOE Ruisheng Technology Co., Ltd., Hefei (CN); BOE Technology Group Co., Ltd., Beijing (CN)

(21) Appl. No.: 18/815,877

(22) Filed: Aug. 27, 2024

Related U.S. Application Data
(63) Continuation of application No. PCT/CN2022/107689, filed on Jul. 25, 2022.

(51) Int. Cl. G09G 3/34; G09G 3/32

(52) U.S. Cl. CPC G09G 3/3426; G09G 3/32; G09G 2310/08; G09G 2320/0233; G09G 2320/0247

(57) ABSTRACT

A backlight module and a driving method therefor, and a display panel and a display apparatus. The backlight module includes: a backlight panel; and a backlight driving circuit, which is used for responding to a first timing signal, so as to output a first brightness signal to drive the backlight panel to emit light, and is used for responding to a second timing signal to output a second brightness signal to drive the backlight panel to emit light. For a frame picture of a first sequence frame, a first brightness signal is output to drive a backlight panel to emit light, and for a frame picture of a second sequence frame, a second brightness signal is output to drive the backlight panel to emit light.

### CROSS-REFERENCE TO RELATED APPLICATION

The present application is a U.S. Continuation Application of International Application No. PCT/CN2022/107689, filed on Jul. 25, 2022, the content of which is incorporated by reference herein in its entirety.

### TECHNICAL FIELD

The present disclosure relates to the field of display technology, and in particular to a backlight module and a driving method therefor, a display panel, and a display device.

### BACKGROUND

During the manufacturing process of a liquid crystal display (LCD) device, control over the liquid crystal is essential to ensure that the LCD device reverses its polarity constantly as images are displayed, thereby preventing damage to the liquid crystal molecules caused by maintaining the same polarity for a long time. In the manufacturing process of current liquid crystal display devices, in order to avoid damage to the liquid crystal molecules, the liquid crystal molecules are often reversed by alternating odd and even frames. However, when the reversal is performed by alternating odd and even frames, the screen will inevitably flicker, thereby reducing the screen display effect of the liquid crystal display device.

It should be noted that the information disclosed in the above background technology section is only used to enhance the understanding of the background of the present disclosure, and therefore may include information that does not constitute prior art known to those skilled in the art.

### SUMMARY

According to an aspect of the present disclosure, there is provided a backlight module, including:
a backlight panel, including a plurality of light-emitting units; and
a backlight driving circuit, electrically connected to the plurality of light-emitting units, where the backlight driving circuit is configured to respond to a first timing signal received at a first sequence frame to output a first brightness signal to drive the plurality of light-emitting units to emit light, and a light-emitting brightness of the backlight panel is a first brightness; and the backlight driving circuit is configured to respond to a second timing signal received at a second sequence frame to output a second brightness signal to drive the plurality of light-emitting units to emit light, and the light-emitting brightness of the backlight panel is a second brightness, the first sequence frame and the second sequence frame are arranged alternately, and the first brightness and the second brightness are different.

According to another aspect of the present disclosure, there is provided a driving method for a backlight module, where the backlight module includes a backlight panel and a backlight driving circuit, the backlight panel includes a plurality of light-emitting units, and the method includes:
obtaining, by the backlight driving circuit, a first brightness signal and a second brightness signal;
outputting, by the backlight driving circuit, the first brightness signal to the plurality of light-emitting units when receiving a first timing signal, a light-emitting brightness of the backlight panel is a first brightness, and the first timing signal is a timing signal sent when displaying a frame picture of a first sequence frame; and
outputting, by the backlight driving circuit, the second brightness signal to the plurality of light-emitting units when receiving a second timing signal, a light-emitting brightness of the backlight panel is a second brightness, and the second timing signal is a timing signal sent when displaying a frame picture of a second sequence frame, the first sequence frame and the second sequence frame are arranged alternately, and the first brightness is different from the second brightness.

According to yet another aspect of the present disclosure, there is provided a display panel, including the backlight module according to any one of the above aspects.

According to still yet another aspect of the present disclosure, there is provided a display device, including the display panel according to the yet another aspect.

It should be understood that the above general description and the detailed description below are only exemplary and explanatory and cannot limit the present disclosure.

### BRIEF DESCRIPTION OF THE DRAWINGS

The drawings herein are incorporated into the specification and constitute a part of the specification, showing embodiments consistent with the present disclosure, and are used together with the specification to explain the principles of the present disclosure. Obviously, the drawings described below are only some embodiments of the present disclosure. For those skilled in the art, other drawings can also be obtained based on these drawings without creative work.

FIG. 1 is a brightness schematic diagram of a frame picture provided by the related art.

FIG. 2 is a structural schematic diagram of a backlight module provided by an embodiment of the present disclosure.

FIG. 3 is a timing diagram of a backlight driving circuit provided by an embodiment of the present disclosure.

FIG. 4 is a brightness schematic diagram of a frame picture provided by an embodiment of the present disclosure.

FIG. 5 is a structural schematic diagram of another backlight module provided by an embodiment of the present disclosure.

FIG. 6 is a driving timing diagram of another backlight driving circuit provided by an embodiment of the present disclosure.

FIG. 7 is a driving timing diagram of another backlight driving circuit provided by an embodiment of the present disclosure.

FIG. 8 is a flow diagram of a driving method for a backlight module provided by an embodiment of the present disclosure.

FIG. 9 is a flow diagram of a method for determining a brightness signal provided by an embodiment of the present disclosure.

FIG. 10 is a schematic diagram of a positive frame picture provided by an embodiment of the present disclosure.

FIG. 11 is a schematic diagram of a negative frame picture provided by an embodiment of the present disclosure.

### DETAILED DESCRIPTION

The embodiments will now be described more fully with reference to the accompanying drawings. However, the embodiments can be implemented in a variety of forms and should not be construed as limited to the embodiments set forth herein; rather, these embodiments are provided so that the present disclosure will be comprehensive and complete and the concepts of the embodiments will be fully conveyed to those skilled in the art. The same reference numerals in the figures represent the same or similar structures, and their detailed descriptions will be omitted. In addition, the drawings are only schematic illustrations of the present disclosure and are not necessarily drawn to scale.

The terms “a”, “an”, “the”, “said”, and “at least one” are used to indicate the presence of one or more elements/components/etc.; the terms “including” and “having” are used to indicate an open-ended inclusion and mean that there may be additional elements/components/etc. in addition to the listed elements/components/etc.; the terms “first”, “second”, and “third”, etc., are used only as markers and are not quantitative restrictions on their objects.

The present disclosure provides a display device, which may be a liquid crystal display device. The display device includes a display panel.

The display panel includes a backlight module, a driving substrate located on one side of the backlight module, a color film substrate located on one side of the driving substrate, and liquid crystal molecules located between the driving substrate and the color film substrate.

Among them, the backlight module includes a backlight panel 1, and the backlight panel 1 includes a plurality of light-emitting units LED. The driving substrate includes a plurality of scanning lines distributed along a first direction and a plurality of data lines distributed along a second direction, as well as a plurality of pixel circuits and a plurality of pixel electrodes corresponding to the plurality of pixel circuits one by one, and the color film substrate includes a common electrode.

A pixel circuit includes a thin film transistor and a parasitic capacitor. The gate electrode of the thin film transistor is electrically connected to a scanning line, and the source electrode of the thin film transistor is electrically connected to a data line. The parasitic capacitor is connected in series between the drain electrode of the thin film transistor and the corresponding pixel electrode. The scanning line is configured to control on and off of the thin film transistor, and the data line is configured to control the voltage loaded on the pixel electrode.

When displaying a picture, multiple light-emitting unit LEDs continue to emit light of the same brightness. At the same time, the thin-film transistor is turned on by controlling the scanning line. After the voltage is applied to the pixel electrode through the data line, the liquid crystal molecules in the corresponding area of the pixel electrode are deflected to adjust the transmittance, thereby achieving different luminous brightness in different areas of the display panel.

When the liquid crystal molecules are deflected, in order to avoid the problem of liquid crystal molecules being damaged by maintaining the same polarity for a long time, the voltage applied to the pixel electrode by the data line is adjusted to achieve periodic reversal of the liquid crystal molecules in the related art. For example, in odd frames, the liquid crystal molecules deflect clockwise after a positive frame voltage is applied to the pixel electrode by a data line, and in even frames, the liquid crystal molecules deflect counterclockwise after a negative frame voltage is applied to the pixel electrode by a data line.

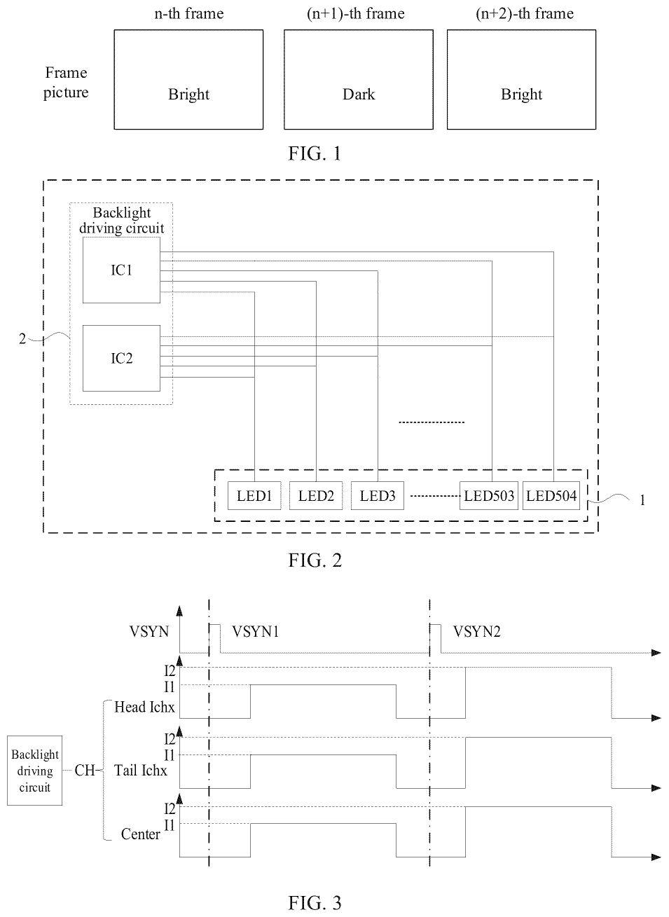

When the voltage loaded on the pixel electrode by a data line switches from a positive frame voltage to a negative frame voltage, the parasitic capacitor included in the pixel circuit corresponding to the pixel electrode will generate leakage current, resulting in a smaller actual voltage loaded on the pixel electrode. In this way, the deflection angle of the liquid crystal molecules in the odd frame is different from that in the even frame, resulting in different transmittances of the liquid crystal molecules in the odd frame and the even frame, which can easily cause the phenomenon of screen flickering. For example, as shown in FIG. 1, three consecutive frames of the picture present a bright, dark, and bright effect, resulting in the phenomenon of screen flickering.

In the embodiment of the present disclosure, in order to reduce the phenomenon of screen flickering, a display panel is proposed, and the display panel includes the backlight module described in the following embodiment.

As shown in FIG. 2, the backlight module includes: a backlight panel 1 and a backlight driving circuit 2. The backlight panel 1 includes a plurality of light-emitting unit LEDs. The backlight driving circuit 2 is electrically connected to the plurality of light-emitting unit LEDs and is configured to respond to the first timing signal VSYN1 received at the first sequence frame to output a first brightness signal I1 to drive the plurality of light-emitting unit LEDs to emit light, and the light-emitting brightness of the backlight panel 1 is the first brightness; and the backlight driving circuit 2 is configured to respond to the second timing signal VSYN2 received at the second sequence frame to output a second brightness signal I2 to drive the plurality of light-emitting unit LEDs to emit light, and the light-emitting brightness of the backlight panel 1 is the second brightness. The first sequence frame and the second sequence frame are alternately arranged, and the first brightness and the second brightness are different.

Thus, in the embodiment of the present disclosure, when displaying the frame picture of the first sequence frame, the backlight driving circuit 2 outputs the first brightness signal I1 to the plurality of light-emitting unit LEDs, so that the light-emitting brightness of the backlight panel 1 is the first brightness. When displaying the frame picture of the second sequence frame, the backlight driving circuit 2 outputs the second brightness signal I2 to the plurality of light-emitting unit LEDs, so that the light-emitting brightness of the backlight panel 1 is the second brightness. Due to the difference between the first brightness and the second brightness, the light-emitting brightness of the backlight panel 1 is adjusted in different sequence frames, thereby adjusting the overall brightness of the entire display picture and reducing the phenomenon of screen flickering.

The first brightness signal I1 and the second brightness signal I2 can be determined in advance and written into the backlight driving circuit 2. The specific determination method of the first brightness signal I1 and the second brightness signal I2 can refer to the embodiment described in the following driving method for backlight module. For example, assuming that the frame pictures of the first sequence of frames are all positive frame pictures, and the frame pictures of the second sequence of frames are all negative frame pictures, if the transmittance of the liquid crystal molecules when displaying the positive frame picture is greater than the transmittance of the liquid crystal molecules when displaying the negative frame picture, then after the first brightness signal I1 and the second brightness signal I2 drive the multiple light-emitting unit LEDs to emit light, the first brightness of the backlight panel 1 is less than the second brightness; if the transmittance of the liquid crystal molecules when displaying the positive frame picture is less than the transmittance of the liquid crystal molecules when displaying the negative frame picture, then after the first brightness signal I1 and the second brightness signal I2 drive the multiple light-emitting unit LEDs to emit light, the first brightness of the backlight panel 1 is greater than the second brightness.

The sum of the frame pictures of the first sequence of frames and the second sequence of frames refers to the period of deflection of the liquid crystal molecules when displaying the picture. That is, one of the frame pictures of the first sequence of frames and the frame pictures of the second sequence of frames is a positive frame picture, and the other is a negative frame picture. In addition, for positive frame pictures and negative frame pictures, for example, when displaying a positive frame picture, the voltage loaded on the first pixel electrode is a positive frame voltage, and the voltage loaded on the second pixel electrode is a negative frame voltage; and when displaying a negative frame picture, the voltage loaded on the first pixel electrode is switched to a negative frame voltage, and the voltage loaded on the second pixel electrode is switched to a positive frame voltage.

Combined with the explanation of the above-mentioned driving substrate, a plurality of pixel electrodes are distributed in an array, and the first pixel electrode and the second pixel electrode are distinguished in a row or column manner. When the first pixel electrode and the second pixel electrode are distinguished in a row manner, each pixel electrode in an odd row of the plurality of pixel electrodes is a first electrode, and each pixel electrode in an even row is a second electrode. That is, each pixel electrode in an odd row of the plurality of pixel electrodes is loaded with a positive frame voltage, and each pixel electrode in an even row is loaded with a negative frame voltage, or each pixel electrode in an odd row of the plurality of pixel electrodes is loaded with a negative frame voltage, and each pixel electrode in an even row is loaded with a positive frame voltage. When the first pixel electrode and the second pixel electrode are distinguished in a column manner, each pixel electrode in an odd column of the plurality of pixel electrodes is a first electrode, and each pixel electrode in an even column is a second electrode. That is, each pixel electrode in an odd column of the plurality of pixel electrodes is loaded with a positive frame voltage, and each pixel electrode in an even column is loaded with a negative frame voltage, or each pixel electrode in an odd column of the plurality of pixel electrodes is loaded with a negative frame voltage, and each pixel electrode in an even column is loaded with a positive frame voltage.

Of course, the first pixel electrode and the second pixel electrode can also be distinguished in a dot matrix manner. For example, assuming that one pixel electrode among the plurality of pixel electrodes is a first pixel electrode, the four pixel electrodes above, below, left, and right thereof are all second pixel electrodes.

The total number of frame pictures of the first sequence frame and the total number of frame pictures of the second sequence frame can be the same or different, which can be determined specifically according to the material of the liquid crystal molecules included in the display panel, as long as the liquid crystal molecules are not damaged during the display of the frame pictures of the first sequence frame and the frame pictures of the second sequence frame, and this is not limited by the embodiments of the present disclosure.

For example, the total number of frame pictures of the first sequence of frames is the same as the total number of frame pictures of the second sequence of frames. For example, the first sequence of frames includes the nth frame and the n+1th frame, and the second sequence of frames includes the n+2th frame and the n+3th frame, where n is an integer greater than or equal to 1; for another example, the first sequence of frames are odd frames, and the second sequence of frames are even frames.

Taking the first sequence of frames being odd frames and the second sequence of frames being even frames as an example, the timing diagram of the backlight driving circuit 2 outputting the first brightness signal I1 and the second brightness signal I2 is shown in FIG. 3. As shown in FIG. 3, VSYN refers to the timing signal received by the backlight driving circuit 2, including the first timing signal VSYN1 corresponding to the odd frame and the second timing signal VSYN2 corresponding to the even frame. I1 refers to the first brightness signal output to the multiple light-emitting unit LEDs by the backlight driving circuit 2 when receiving the first timing signal VSYN1, and I2 refers to the second brightness signal output to the multiple light-emitting unit LEDs by the backlight driving circuit 2 when receiving the second timing signal VSYN2. As shown in FIG. 3, the first brightness signal I1 and the second brightness signal I2 outputted by the backlight driving circuit 2 to the light-emitting unit both include a head signal Head Ichx, an intermediate signal Center, and a tail signal Tail Ichx.

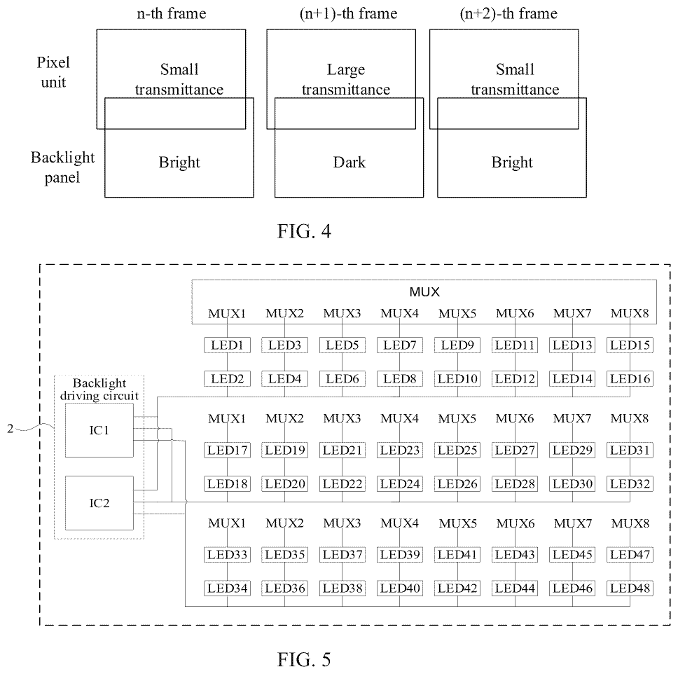

Further, for a display panel including the backlight module, after adjusting the light-emitting brightness of the backlight panel 1, taking the first sequence frame being an odd frame and the second sequence frame being an even frame as an example, as shown in FIG. 4, for each frame picture, the overall brightness of the display panel includes the transmittance of the pixel unit and the brightness of the backlight panel 1.

As shown in FIG. 4, if the transmittance of the pixel unit is small, the luminous brightness of the backlight panel 1 needs to be brightened, and if the transmittance of the pixel unit is large, the luminous brightness of the backlight panel 1 needs to be dimmed, so as to ensure that the brightness difference between the overall brightness of each frame picture is not too large, thereby reducing the phenomenon of screen flickering.

In the embodiment of the present disclosure, when the backlight driving circuit 2 drives multiple light-emitting unit LEDs to emit light, the multiple light-emitting unit LEDs can be driven to emit light by active driving, or by passive driving. Of course, multiple light-emitting unit LEDs can also be driven to emit light by other driving methods.

When the backlight driving circuit 2 drives multiple light-emitting unit LEDs to emit light in an active driving manner, the timing of the backlight driving circuit 2 is shown in FIG. 3. When the backlight driving circuit 2 drives multiple light-emitting unit LEDs to emit light in a passive driving manner, as shown in FIG. 5, the backlight module further includes a multiplexer circuit MUX, which is electrically connected to the backlight driving circuit 2 and the multiple light-emitting unit LEDs, respectively. The multiplexer circuit MUX is configured to respond to the first multiplexed signal MUX1 to the Nth multiplexed signal MUXN to sequentially connect the backlight driving circuit 2 and the multiple light-emitting unit LEDs.

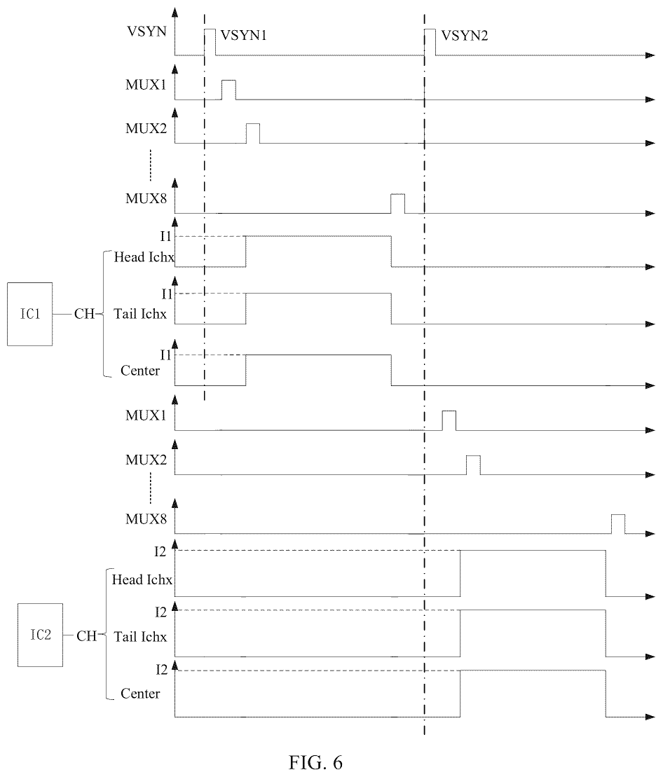

Continuing to take the first sequence frame being an odd frame and the second sequence frame being an even frame as an example, at this time, the backlight driving circuit 2 drives multiple light-emitting unit LEDs to emit light in a passive driving manner, and the timing diagram of the backlight driving circuit 2 outputting the first brightness signal I1 and the second brightness signal I2 is shown in FIG. 6. As shown in FIG. 6, VSYN refers to the timing signal received by the backlight driving circuit 2, including the first timing signal VSYN1 corresponding to the odd frame and the second timing signal VSYN2 corresponding to the even frame. MUXn refers to the multiplexed signal received by the multiplexer circuit MUX, including the first multiplexed signal MUX1, the second multiplexed signal MUX2, . . . , and the eighth multiplexed signal MUX8. I1 refers to the first brightness signal output to the plurality of light-emitting unit LEDs by the backlight driving circuit 2 when receiving the first timing signal VSYN1, and I2 refers to the second brightness signal output to the plurality of light-emitting unit LEDs by the backlight driving circuit 2 when receiving the second timing signal VSYN2.

In the embodiment of the present disclosure, when the backlight driving circuit 2 outputs the first brightness signal I1 or the second brightness signal I2 to the plurality of light-emitting unit LEDs, in order to ensure the timing of the first brightness signal I1 and the second brightness signal I2, it can be controlled in different ways.

In some embodiments, as shown in FIG. 5 or FIG. 6, the backlight driving circuit 2 includes a first driving circuit IC1 and a second driving circuit IC2, and the first driving circuit IC1 and the second driving circuit IC2 are both electrically connected to a plurality of light-emitting unit LEDs. The first driving circuit IC1 is configured to respond to the first timing signal VSYN1 received at the first sequence frame to output a first brightness signal I1 to drive the plurality of light-emitting unit LEDs to emit light, and the second driving circuit IC2 is configured to respond to the second timing signal VSYN2 received at the second sequence frame to output a second brightness signal I2 to drive the plurality of light-emitting unit LEDs to emit light.

In this way, the first driving circuit IC1 and the second driving circuit IC2 can be controlled to work alternately by the timing signal. That is, in the first sequence frame, the first driving circuit IC1 works and the second driving circuit IC2 does not work, and in the second sequence frame, the first driving circuit IC1 does not work and the second driving circuit IC2 works.

The first brightness signal I1 can be pre-written into the first driving circuit IC1, and the second brightness signal I2 can be pre-written into the second driving circuit IC2.

In the embodiment of the present disclosure, when the first timing signal VSYN1 is received, the first driving circuit IC1 outputs the first brightness signal I1 to the plurality of light-emitting unit LEDs, and when the second timing signal VSYN2 is received, the second driving circuit IC2 outputs the second brightness signal I2 to the plurality of light-emitting unit LEDs, thereby realizing the separate control of the first brightness signal I1 and the second brightness signal I2, and effectively improving the effectiveness of the control of the first brightness signal I1 and the second brightness signal I2.

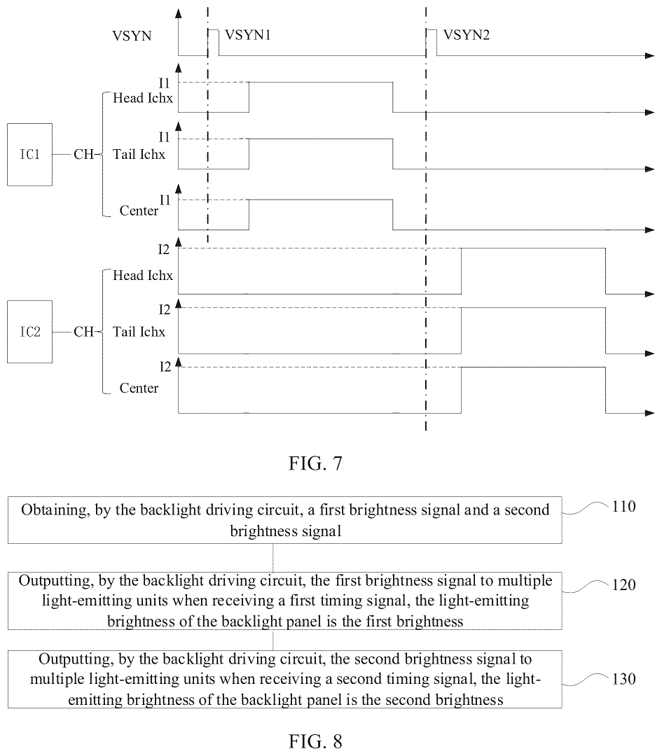

Continuing to take the first sequence frame being an odd frame and the second sequence frame being an even frame as an example, at this time, the first driving circuit IC1 and the second driving circuit IC2 both drive the plurality of light-emitting unit LEDs to emit light in a passive driving manner, and the timing diagram of the first driving circuit IC1 and the second driving circuit IC2 outputting the first brightness signal I1 and the second brightness signal I2 is shown in FIG. 7. As shown in FIG. 7, VSYN1 refers to the first timing signal corresponding to the odd frame received by the first driving circuit IC1, VSYN2 refers to the second timing signal corresponding to the even frame received by the second driving circuit IC2. MUXn refers to the multiplexed signal received by the multiplexer circuit MUX, including the first multiplexed signal MUX1, the second multiplexed signal MUX2, . . . , the eighth multiplexed signal MUX8. I1 refers to the first brightness signal output to the plurality of light-emitting unit LEDs by the first driving circuit IC1 when receiving the first timing signal VSYN1, and I2 refers to the second brightness signal output to the plurality of light-emitting unit LEDs by the second driving circuit IC2 when receiving the second timing signal VSYN2.

In some other embodiments, the backlight driving circuit 2 includes a third driving circuit and a compensation circuit. The third driving circuit is electrically connected to the compensation circuit, and the compensation circuit is electrically connected to the plurality of light-emitting unit LEDs.

The third driving circuit is configured to output a loading signal to the compensation circuit, and the compensation circuit is configured to respond to the first timing signal VSYN1 received at the odd frame to output the loading signal as the first brightness signal I1 to multiple light-emitting unit LEDs; and the compensation circuit is configured to respond to the second timing signal VSYN2 received at the even frame to amplify the loading signal, and output the amplified loading signal as the second brightness signal I2 to multiple light-emitting unit LEDs. In this way, when the first brightness signal I1 and the second brightness signal I2 are alternately output to multiple light-emitting unit LEDs in the above manner, the third driving circuit does not need to perform timing control, thereby simplifying the circuit structure.

The loading signal can be written into the third driving circuit in advance, and the amplification factor of the compensation circuit can be written into the compensation circuit. The loading signal is the first brightness signal I1, and the amplification factor of the compensation circuit is the ratio of the second brightness signal I2 to the first brightness signal I1.

For the compensation circuit, if the brightness signal is a current signal, the compensation circuit is a current compensation circuit; if the brightness signal is a voltage signal, the compensation circuit is a voltage compensation circuit. The compensation circuit is an amplifier circuit controlled by timing. That is, when the compensation circuit receives the first timing signal VSYN1, the input loading signal is not amplified, that is, the input loading signal is directly output as the first brightness signal I1 to multiple light-emitting unit LEDs; when the compensation circuit receives the second timing signal VSYN2, the input loading signal is amplified, and then the amplified loading signal is output as the second brightness signal I2 to multiple light-emitting unit LEDs.

The embodiment of the present disclosure also provides a driving method for a backlight module. The backlight module includes a backlight panel and a backlight driving circuit, and the backlight panel includes multiple light-emitting units. As shown in FIG. 8, the method includes the following steps S110-S130.

Step S110, obtaining, by the backlight driving circuit, a first brightness signal and a second brightness signal.

Step S120, outputting, by the backlight driving circuit, the first brightness signal to multiple light-emitting units when receiving a first timing signal, the light-emitting brightness of the backlight panel is the first brightness, and the first timing signal is a timing signal sent when displaying the frame picture of the first sequence frame.

Step S130, outputting, by the backlight driving circuit, the second brightness signal to multiple light-emitting units when receiving a second timing signal, the light-emitting brightness of the backlight panel is the second brightness when the backlight driving circuit receives a second timing signal, and the second timing signal is a timing signal sent when displaying the frame picture of the second sequence frame. The first sequence frame and the second sequence frame are arranged alternately, and the first brightness and the second brightness are different.

In the embodiment of the present disclosure, when displaying the frame picture of the first sequence frame, the backlight driving circuit outputs a first brightness signal to a plurality of light-emitting units, so that the luminous brightness of the backlight panel is the first brightness. When displaying the frame picture of the second sequence frame, the backlight driving circuit outputs a second brightness signal to a plurality of light-emitting units, so that the luminous brightness of the backlight panel is the second brightness. Due to the difference between the first brightness and the second brightness, the luminous brightness of the backlight panel is adjusted in different sequence frames, thereby adjusting the overall brightness of the entire display screen, and reducing the phenomenon of screen flickering.

In the above step S110, the first brightness signal and the second brightness signal can be pre-written into the backlight driving circuit. For each frame picture, when driving multiple light-emitting units to emit light, the first brightness signal and the second brightness signal can be directly called, thereby avoiding repeated acquisitions, resulting in waste of resources, and improving the driving efficiency of the light-emitting units.

In addition, in combination with the backlight module described in the above embodiment, the backlight driving circuit includes a first driving circuit and a second driving circuit, or includes a third driving circuit and a compensation circuit.

When the backlight driving circuit includes a first driving circuit and a second driving circuit, the first brightness signal can be pre-written into the first driving circuit, and the second brightness signal can be pre-written into the second driving circuit. In this way, in the subsequent step S120, the first brightness signal can be directly called by the first driving circuit, and in the subsequent step S130, the second brightness signal can be directly called by the second driving circuit.

When the backlight driving circuit includes a third driving circuit and a compensation circuit, the third driving circuit obtains a loading signal and outputs it to the compensation circuit. When the compensation circuit receives the first timing signal, the loading signal is determined as the first brightness signal, and when the compensation circuit receives the second timing signal, the loading signal is amplified, and the amplified loading signal is used as the second brightness signal.

The loading signal is the first brightness signal, and the amplification factor of the compensation circuit is the ratio of the second brightness signal to the first brightness signal. In addition, the loading signal can be written into the third driving circuit in advance, and the amplification factor of the compensation circuit can be written into the compensation circuit. In the subsequent steps S120 and S130, the loading signal can be directly called by the third driving circuit, and the amplification factor can be directly called by the compensation circuit in step S130.

In the above steps S120 and S130, the specific explanation of the first sequence frame and the second sequence frame involved can be referred to the above embodiment, and the embodiment of the present disclosure will not be repeated. For example, the first sequence frame is an odd frame, and the second sequence frame is an even frame.

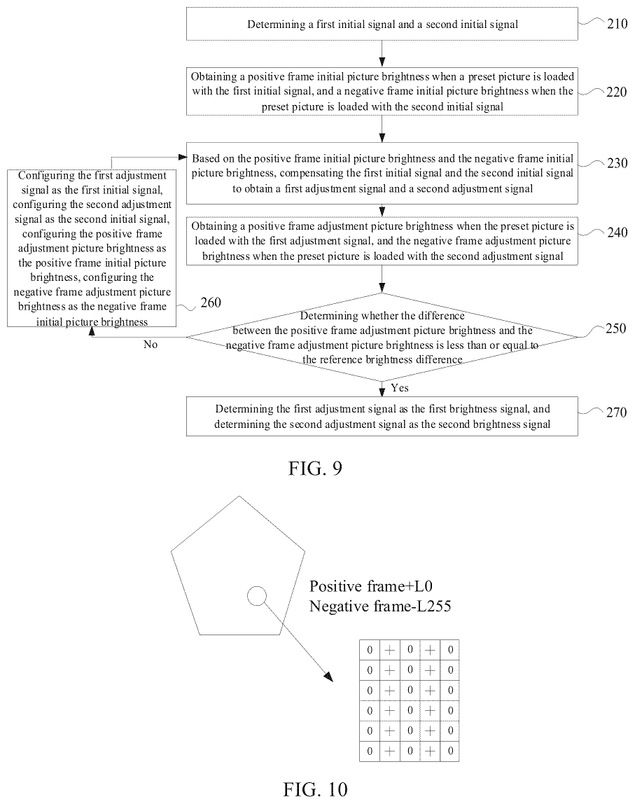

In the embodiment of the present disclosure, before the first brightness signal and the second brightness signal are obtained in the above step S110, as shown in FIG. 9, the first brightness signal and the second brightness signal can be determined by the following steps S210-S270.

Step S210, determining a first initial signal and a second initial signal.

Step S220, obtaining a positive frame initial picture brightness when a preset picture is loaded with the first initial signal, and a negative frame initial picture brightness when the preset picture is loaded with the second initial signal.

Step S230, based on the positive frame initial picture brightness and the negative frame initial picture brightness, compensating the first initial signal and the second initial signal to obtain a first adjustment signal and a second adjustment signal.

Step S240, obtaining a positive frame adjustment picture brightness when the preset picture is loaded with the first adjustment signal, and the negative frame adjustment picture brightness when the preset picture is loaded with the second adjustment signal. Step S250, determining whether the difference between the positive frame adjustment picture brightness and the negative frame adjustment picture brightness is less than or equal to the reference brightness difference.

Step S260, if not, configuring the first adjustment signal as the first initial signal, configuring the second adjustment signal as the second initial signal, configuring the positive frame adjustment picture brightness as the positive frame initial picture brightness, configuring the negative frame adjustment picture brightness as the negative frame initial picture brightness, and returning to the above step S230.

Step S270, if yes, determining the first adjustment signal as the first brightness signal, and determining the second adjustment signal as the second brightness signal.

In the above step S210, the first initial signal and the second initial signal can be the same or different. The first initial signal and the second initial signal are pre-set initial brightness signals loaded on multiple light-emitting units of the backlight panel.

In the above steps S220 and S240, the brightness of the picture can be detected by an optical detector.

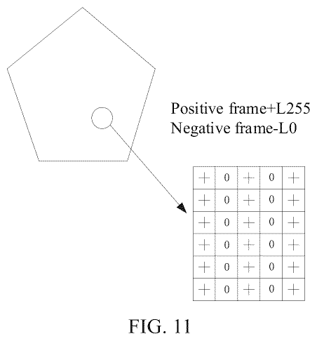

In the above step S220, the frame picture of the first sequence frame can be defined as a positive frame picture, as shown in FIG. 10, and the frame picture of the second sequence frame can be defined as a negative frame picture, as shown in FIG. 11. At this time, the first adjustment signal determined in the subsequent step S270 is the first brightness signal, and the second adjustment signal is the second brightness signal. Of course, the frame picture of the first sequence frame can also be defined as a negative frame picture, and the frame picture of the second sequence frame can be defined as a positive frame picture. At this time, the first adjustment signal determined in the subsequent step S270 is the second brightness signal, and the second adjustment signal is the first brightness signal, and this is not limited by the embodiment of the present disclosure.

The preset picture can be any pre-set picture to be displayed. When loading the first initial signal or the second initial signal, the positive frame voltage and the negative frame voltage can be loaded in a column loading manner, or the positive frame voltage and the negative frame voltage can be loaded in a row manner. Of course, the preset picture can also load the positive frame voltage and the negative frame voltage in a dot matrix manner. For details, please refer to the method of applying voltage to the pixel electrode described in the above embodiment, which is not limited in the embodiment of the present disclosure.

In the above step S230, at least one of the first initial signal and the second initial signal can be adjusted by step compensation. For example, the initial signal corresponding to the darker one of the positive frame initial picture brightness and the negative frame initial picture brightness can be increased; or the initial signal corresponding to the brighter one of the positive frame initial picture brightness and the negative frame initial picture brightness can be decreased; or the initial signal corresponding to the darker one of the positive frame initial picture brightness and the negative frame initial picture brightness can be increased, and the initial signal corresponding to the brighter one can be decreased.

In some embodiments, a compensation signal is obtained. The initial signal corresponding to the darker picture brightness of the positive frame initial picture brightness and the negative frame initial picture brightness is determined as a to-be-compensated signal, and the sum of the to-be-compensated signal and the compensation signal is determined as the corresponding adjustment signal; the initial signal corresponding to the brighter picture brightness of the positive frame initial picture brightness and the negative frame initial picture brightness is determined as a non-compensation signal, and the non-compensation signal is determined as the corresponding adjustment signal.

In other embodiments, a compensation signal is obtained. The initial signal corresponding to the darker picture brightness of the positive frame initial picture brightness and the negative frame initial picture brightness is determined as a non-compensation signal, and the non-compensation signal is determined as a corresponding adjustment signal; the initial signal corresponding to the brighter picture brightness of the positive frame initial picture brightness and the negative frame initial picture brightness is determined as a to-be-compensated signal, and the sum of the to-be-compensated signal and the compensation signal is determined as the corresponding adjustment signal.

In the above two embodiments, the compensation signal can be a compensation current or a compensation voltage. Taking the compensation signal being a compensation current as an example, the compensation current is greater than or equal to 1.2 microamperes and less than or equal to 39 microamperes. For example, the compensation current is 20 microamperes.

In the above step S250, the magnitude relationship between the brightness difference of the positive frame adjustment picture brightness and the negative frame adjustment picture brightness and the reference brightness difference is determined. Since the smaller the brightness difference between the two frames of the picture, the smaller the screen flickering phenomenon occurs. Therefore, in some examples, the reference brightness difference is less than or equal to 98 nits. For example, the reference brightness difference is 85 nits, 80 nits, 75 nits, etc.

It should be noted that although the various steps of the driving method for the backlight module in the present disclosure are described in a specific order in FIG. 8, this does not require or imply that the steps must be performed in this specific order, or that all the steps shown must be performed to achieve the desired results. Additionally, or alternatively, some steps may be omitted, multiple steps may be combined into one step, and/or one step may be decomposed into multiple steps, etc.

After considering the specification and practicing the disclosure herein, it will be easy for those skilled in the art to think of other embodiments of the present disclosure. This application is intended to cover any variations, uses or adaptations of the present disclosure, which follow the general principles of the present disclosure and include common knowledge or customary technical means in the art that are not disclosed in the present disclosure. The description and examples are to be regarded as exemplary only, and the true scope and spirit of the present disclosure are indicated by the appended claims.

What is claimed is:

1. A backlight module, comprising:
a backlight panel, comprising a plurality of light-emitting units; and
a backlight driving circuit, electrically connected to the plurality of light-emitting units, wherein the backlight driving circuit is configured to respond to a first timing signal received at a first sequence frame to output a first brightness signal to drive the plurality of light-emitting units to emit light, and a light-emitting brightness of the backlight panel is a first brightness; and the backlight driving circuit is configured to respond to a second timing signal received at a second sequence frame to output a second brightness signal to drive the plurality of light-emitting units to emit light, and the light-emitting brightness of the backlight panel is a second brightness, the first sequence frame and the second sequence frame are arranged alternately, and the first brightness and the second brightness are different.

2. The backlight module according to claim 1, wherein the backlight driving circuit comprises a first driving circuit and a second driving circuit; and
the first driving circuit and the second driving circuit are electrically connected to the plurality of light-emitting units, and the first driving circuit is configured to respond to the first timing signal received at the first sequence frame to output the first brightness signal to drive the plurality of light-emitting units to emit light, and the second driving circuit is configured to respond to the second timing signal received at the second sequence frame to output the second brightness signal to drive the plurality of light-emitting units to emit light.

3. The backlight module according to claim 1, wherein the backlight driving circuit comprises a third driving circuit and a compensation circuit;
the third driving circuit is electrically connected to the compensation circuit, and the compensation circuit is electrically connected to the plurality of light-emitting units; and
the third driving circuit is configured to output a loading signal to the compensation circuit, and the compensation circuit is configured to respond to the first timing signal received at an odd frame to output the loading signal as the first brightness signal to the plurality of light-emitting units; and the third driving circuit is configured to respond to the second timing signal received at an even frame to amplify the loading signal, and output the amplified loading signal as the second brightness signal to the plurality of light-emitting units.

4. The backlight module according to claim 1, wherein the backlight module further comprises a multiplexer circuit; and
the multiplexer circuit is electrically connected to the backlight driving circuit and the plurality of light-emitting units respectively, and the multiplexer circuit is configured to respond to a first multiplexed signal to a Nth multiplexed signal to sequentially connect the backlight driving circuit and the plurality of light-emitting units.

5. The backlight module according to claim 1, wherein the first sequence frame is an odd frame, and the second sequence frame is an even frame.

6. A driving method for a backlight module, wherein the backlight module comprises a backlight panel and a backlight driving circuit, the backlight panel comprises a plurality of light-emitting units, and the method comprises:
obtaining, by the backlight driving circuit, a first brightness signal and a second brightness signal;
outputting, by the backlight driving circuit, the first brightness signal to the plurality of light-emitting units when receiving a first timing signal, a light-emitting brightness of the backlight panel is a first brightness, and the first timing signal is a timing signal sent when displaying a frame picture of a first sequence frame; and
outputting, by the backlight driving circuit, the second brightness signal to the plurality of light-emitting units when receiving a second timing signal, a light-emitting brightness of the backlight panel is a second brightness, and the second timing signal is a timing signal sent when displaying a frame picture of a second sequence frame, the first sequence frame and the second sequence frame are arranged alternately, and the first brightness is different from the second brightness.

7. The method according to claim 6, wherein the backlight driving circuit comprises a third driving circuit and a compensation circuit, and obtaining, by the backlight driving circuit, the first brightness signal and the second brightness signal comprises:
obtaining, by the third driving circuit, a loading signal and outputting the loading signal to the compensation circuit; and
determining, by the compensation circuit, the loading signal as the first brightness signal when receiving the first timing signal, and amplifying the loading signal and using the amplified loading signal as the second brightness signal when receiving the second timing signal.

8. The method according to claim 6, wherein the first sequence frame is an odd frame, and the second sequence frame is an even frame.

9. The method according to claim 6, wherein before obtaining, by the backlight driving circuit, the first brightness signal and the second brightness signal, the method further comprises:
determining a first initial signal and a second initial signal;
obtaining a positive frame initial picture brightness when a preset picture is loaded with the first initial signal, and a negative frame initial picture brightness when the preset picture is loaded with the second initial signal;
obtaining a first adjustment signal and a second adjustment signal by compensating the first initial signal and the second initial signal based on the positive frame initial picture brightness and the negative frame initial picture brightness;
obtaining a positive frame adjustment picture brightness when the preset picture is loaded with the first adjustment signal, and a negative frame adjustment picture brightness when the preset picture is loaded with the second adjustment signal;
in response to determining that a difference between the positive frame adjustment picture brightness and the negative frame adjustment picture brightness is greater than a reference brightness difference, configuring the first adjustment signal as the first initial signal, configuring the second adjustment signal as the second initial signal, configuring the positive frame adjustment picture brightness as the positive frame initial picture brightness, configuring the negative frame adjustment picture brightness as the negative frame initial picture brightness, and returning to the step of compensating the first initial signal and the second initial signal; and
in response to determining that the difference between the positive frame adjustment picture brightness and the negative frame adjustment picture brightness is less than or equal to the reference brightness difference, determining the first adjustment signal as the first brightness signal, and determining the second adjustment signal as the second brightness signal.

10. The method according to claim 9, wherein obtaining the first adjustment signal and the second adjustment signal by compensating the first initial signal and the second initial signal based on the positive frame initial picture brightness and the negative frame initial picture brightness comprises:
obtaining a compensation signal;
determining an initial signal corresponding to a darker picture brightness of the positive frame initial picture brightness and the negative frame initial picture brightness as a signal to be compensated, and determining a sum of the signal to be compensated and the compensation signal as corresponding adjustment signal; and
determining an initial signal corresponding to a brighter picture brightness of the positive frame initial picture brightness and the negative frame initial picture brightness as a non-compensated signal, and determining the non-compensated signal as corresponding adjustment signal.

11. The method according to claim 9, wherein obtaining the first adjustment signal and the second adjustment signal by compensating the first initial signal and the second initial signal based on the positive frame initial picture brightness and the negative frame initial picture brightness comprises:
obtaining a compensation signal;
determining an initial signal corresponding to a darker picture brightness of the positive frame initial picture brightness and the negative frame initial picture brightness as a non-compensated signal, and determining the non-compensated signal as corresponding adjustment signal; and
determining an initial signal corresponding to a brighter picture brightness of the positive frame initial picture brightness and the negative frame initial picture brightness as a signal to be compensated, and determining a sum of the signal to be compensated and the compensation signal as corresponding adjustment signal.

12. The method according to claim 10, wherein the compensation signal is a compensation current, and the compensation current is greater than or equal to 1.2 microamperes and less than or equal to 39 microamperes.

13. The method according to claim 11, wherein the compensation signal is a compensation current, and the compensation current is greater than or equal to 1.2 microamperes and less than or equal to 39 microamperes.

14. The method according to claim 12, wherein the compensation current is 20 microamperes.

15. The method according to claim 13, wherein the compensation current is 20 microamperes.

16. The method according to claim 9, wherein the reference brightness difference is less than or equal to 98 nits.

17. A display panel, comprising the backlight module according to claim 1.

18. A display device, comprising the display panel according to claim 17.
